(19) United States
(12) Patent Application Publication
(10) Pub. No.: US 2024/0261783 A1
(43) Pub. Date: Aug. 8, 2024

(54) VERTICAL CARTRIDGES AND SYSTEMS COMPRISING THE SAME FOR PROCESSING FLUID SAMPLES

(71) Applicant: TrustBio Corporation, NEW TAIPEI CITY (TW)

(72) Inventor: Chun-Chao WANG, New Taipei City (TW)

(21) Appl. No.: 18/427,874

(22) Filed: Jan. 31, 2024

(30) Foreign Application Priority Data
Feb. 4, 2023 (TW) 112104027

(51) Int. Cl. B01L 3/00

(52) U.S. Cl. CPC B01L 3/50273; B01L 2200/12; B01L 2300/047; B01L 2300/0609; B01L 2300/0816; B01L 2300/087; B01L 2300/1805; B01L 2400/0442

(57) ABSTRACT

Disclosed herein is a cartridge and a system including the same for vertically processing a fluid sample. The cartridge includes a case and a cover for covering the case, in which the case includes a receiving chamber having a round bottom, a plurality of reaction chambers downstream to the receiving chamber, a plurality of fluid channels connecting the plurality of reaction chambers to the round bottom of the receiving chamber; and a plurality of air passages downstream to the reaction chambers and respectively connected thereto; in which the receiving chamber includes an inlet for receiving the fluid sample, and a baffle plate disposed underneath the inlet and above the round bottom. The system includes the present cartridge, a heating module for elevating the temperature of the reaction chambers, a moving module for moving the cartridge vertically, and optionally a detection module for detecting the reaction products in the reaction chambers.

### CROSS-REFERENCES TO RELATED APPLICATIONS

This application claims priority and the benefit of Taiwan Patent Application No. 112104027, filed Feb. 4, 2023, the entireties of which is incorporated herein by reference.

### BACKGROUND OF THE INVENTION

### 1. FIELD OF THE INVENTION

The present disclosure relates to a cartridge and a system comprising the same for processing a fluid sample in vertical manner. More particularly, the disclosure invention relates to a cartridge, in which the process of the sample in the cartridge is self-driven or without the need of electricity to drive the process in the cartridge.

### 2. DESCRIPTION OF RELATED ART

Micro-detection, in which a minimum amount of a sample is used for detection purpose, is advantageous in the field of clinical diagnosis and detection. Various reagents suitable for use in processes (e.g., enzyme-linked immunosorbent assay) that use only minimum amounts of a sample have been developed, so that the sample may be analyzed easily and efficiently. However, most devices for carrying out such process are driven via electricity, as the sample cannot pass the microfluid channels without being driven via micro pumps coupled thereto. Further, most of the devices are designed to carry out the process on a flat plane, accordingly, relatively larger amount of the sample is needed.

In view of the above, there exists in the related art a need of an improved device for processing a sample, in which the process of the sample in the improved device may be driven without electricity and in the spent of only minimum amount of the sample.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present disclosure aims to provide a cartridge for vertically processing a fluid sample. The cartridge comprises a case and a cover for covering the case, in which the case comprises a receiving chamber having a round bottom, a plurality of reaction chambers downstream to the receiving chamber, a plurality of fluid channels connecting the plurality of reaction chambers to the round bottom of the receiving chamber; and a plurality of air passages downstream to the plurality of reaction chambers and respectively connected thereto; the receiving chamber comprises an inlet for receiving the fluid sample, and a baffle plate disposed underneath the inlet and above the round bottom; and the receiving chamber, the plurality of reaction chambers, and the plurality of fluid channels are in fluid communication with each other.

According to embodiments of the present disclosure, each reaction chamber is leveled with the other reaction chambers.

According to embodiments of the present disclosure, the cartridge has even numbers of the reaction chambers, the fluid channels and the air passages disposed evenly on the left and right sides of the receiving chamber. According to preferred embodiments of the present disclosure, the cartridge has six reaction chambers, six fluid channels and six air passages disposed evenly on the left and right sides of the receiving chamber.

According to embodiments of the present disclosure, each fluid channel is in U-shaped and has a length different from that of another fluid channel disposed on the same side of the receiving chamber; and the six air passages independently has the same length.

According to embodiments of the present disclosure, the baffle plate serves as an indicator for indicating the volume of the fluid sample received in the receiving chamber.

According to optional embodiments of the present disclosure, the cartridge further comprises a plurality of C-shaped elements respectively disposed within the plurality of reaction chambers.

According to embodiments of the present disclosure, each C-shaped elements has an angular opening of about 20 to 150 degrees.

According to certain embodiments of the present disclosure, the cartridge has six reaction chambers, six fluid channels and six air passages disposed evenly on the left and right side of the receiving chamber; and the C-shaped elements disposed within the reaction chambers on the left or right sides of the receiving chamber respectively have the angular openings of 60, 90 and 120 degrees.

According to embodiments of the present disclosure, each reaction chamber is leveled with the other reaction chambers.

According to embodiments of the present disclosure, each fluid channel is in U-shaped and has a length different from that of another fluid channel disposed on the same side of the receiving chamber; and the six air passages are all in the same length.

In another aspect, the present disclosure provides a system for vertically processing a fluid sample. The system comprises the cartridge of the present disclosure; a heating module coupled to the cartridge of the present disclosure for elevating the temperature of each reaction chambers; and a moving module coupled to the cartridge of the present disclosure for moving the present cartridge in vertical direction.

According to embodiments of the present disclosure, the heating module comprises a heating plate and a plurality of heating areas evenly disposed on the left and right sides of the heating plate, and each heating area on the left or right sides has a temperature different from that of another heating area on the same side.

According to embodiments of the present disclosure, the moving module comprises a gear groove disposed around the case and two gears respectively disposed on each side of the case for moving the cartridge along the gear groove in vertical direction.

According to optional embodiments of the present disclosure, the system further comprises a detection module for detecting the fluid sample in any one of the reacting chambers.

In all embodiments, the fluid sample is any one of a whole blood sample, a plasma sample, a serum sample, a urine sample, a mucus sample, a saliva sample and purified or filtered forms thereof.

Many of the attendant features and advantages of the present disclosure will becomes better understood with reference to the following detailed description considered in connection with the accompanying drawings.

### BRIEF DESCRIPTION OF THE DRAWINGS

The present description will be better understood from the following detailed description read in light of the accompanying drawings, where:

FIG. 1A is a schematic diagram depicting a cartridge 100 in accordance with one preferred embodiment of the present disclosure;

FIG. 1B is a top view of the cartridge 100 of FIG. 1A in a standing position;

FIG. 1C is the front view of the cartridge 100 of FIG. 1B;

FIG. 1D is the front view of the cartridge 100 of

FIG. 2A is an exploded view of a system 280 for processing a fluid sample in accordance with one embodiment of the present disclosure;

FIG. 2B is the front view of the system 280 of FIG. 2A;

FIG. 2C is a perspective view of the system 280 of FIG. 2A; and

FIG. 3 are schematic diagrams depicting the movement of the detection module 270 in relative to the cartridge 200 when the system 280 is in use in accordance with one embodiment of the present disclosure.

In accordance with common practice, the various described features/elements are not drawn to scale but instead are drawn to best illustrate specific features/elements relevant to the present invention. Also, like reference numerals and designations in the various drawings are used to indicate like elements/parts.

### DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

### 1. Definition

For convenience, certain terms employed in the specification, examples and appended claims are collected here.

The term “fluid sample” as used herein refers to any fluid biological sample suitable for being processed by the cartridge and/or system of the present disclosure. Examples of the fluid sample suitable for use in the present disclosure include, but are not limited to, a whole blood sample, a plasma sample, a serum sample, a urine sample, a mucus sample, a saliva sample, and purified or filtered forms thereof. Preferably, the fluid sample contains nucleic acids of its host. Alternatively, or optionally, the fluid sample may be pre-treated with a buffer solution such as a phosphate buffered saline (PBS) and the like.

The term “movable module” as used herein refers to mechanical means incorporated in the present system for moving the present cartridge in lateral and/or vertical directions, such as moving up and down, left and right, and combination thereof.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about”. Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques.

Unless defined otherwise, all technical and scientific terms used herein have the same meaning as commonly understood by one of the ordinary skilled in the art to which this invention belongs.

The singular forms “a”, “and”, and “the” are used herein to include plural referents unless the context clearly dictates otherwise.

### 2. The Cartridge

The present disclosure provides a novel cartridge and a system comprising the same for processing a fluid biological sample in vertical manner.

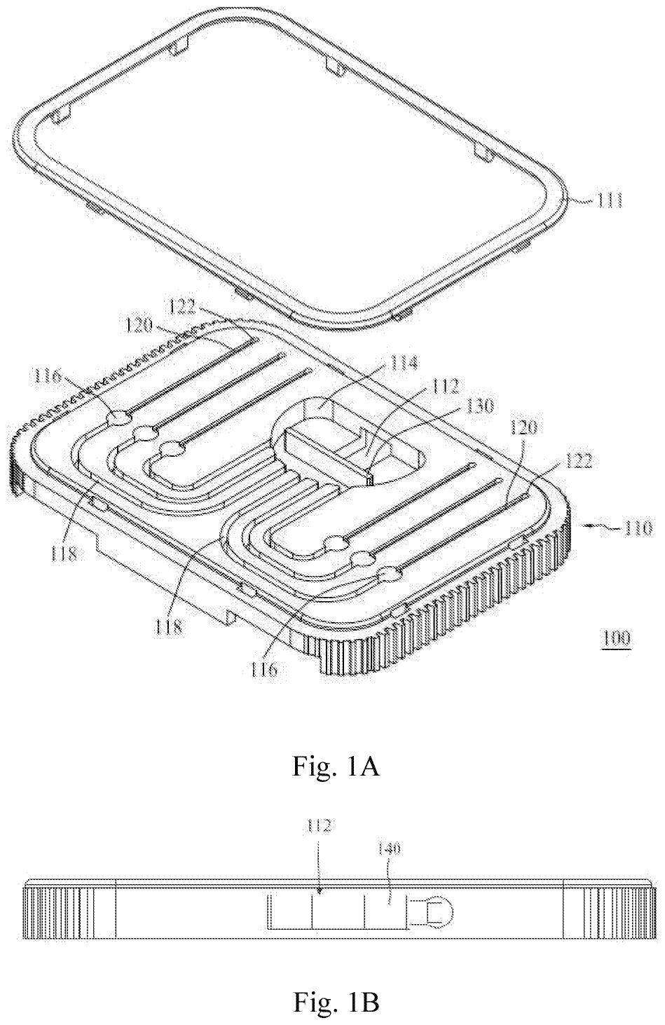

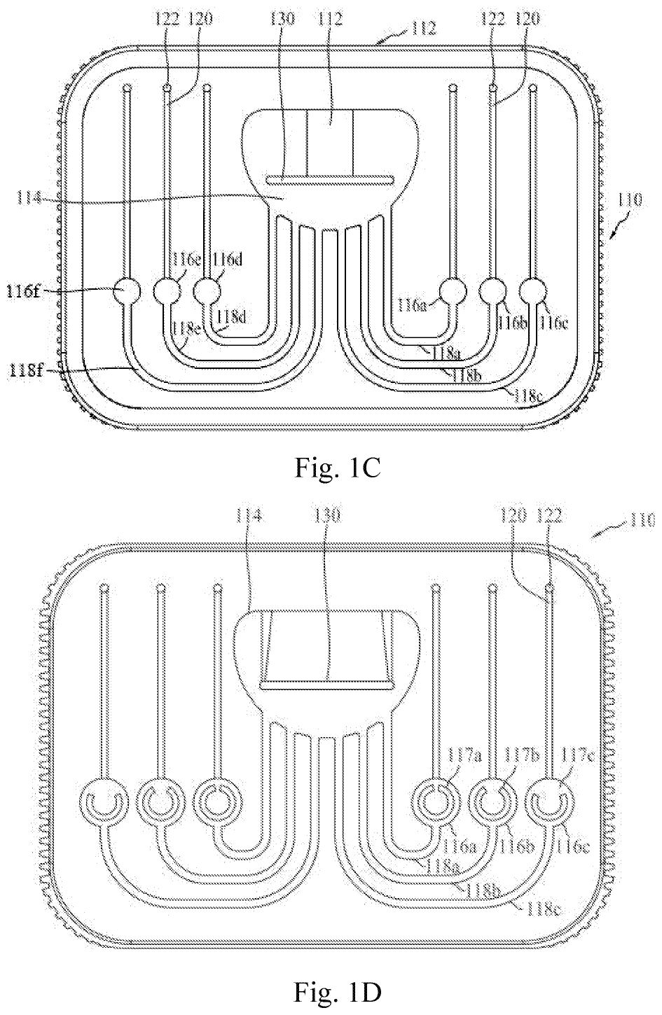

Reference is made to FIGS. 1A to 1D, in which FIG. 1A is a perspective view of a cartridge 100 for processing a fluid sample, FIG. 1B is a top view of the cartridge 100 in a standing position, FIG. 1C is the front view of the cartridge 100 of FIG. 1B, and FIG. 1D is a schematic diagram depicting an alternative embodiment of the cartridge 100.

The cartridge 100 of the present disclosure is suitable for use in instruments specifically for conducting nucleic acid related reactions such as polymeric chain reaction (PCR), and the like. The cartridge 100 includes at least, a case 110 and a cover 111, which covers the case 110. The case 110 comprises in its structure, a receiving chamber 114 having a round bottom, a plurality of reaction chambers 116 downstream to the receiving chamber 114, a plurality of fluid channels 118 connecting the plurality of reaction chambers 116 to the round bottom of the receiving chamber 114; and a plurality of air passages 120 downstream to the plurality of reaction chambers 116 and respectively connected thereto. The receiving chamber 114 has an inlet 112 for receiving a fluid sample to be processed, and a baffle plate 130 disposed underneath the inlet 112 and above the round bottom. Additionally, or optionally, as depicted in FIG. 1B, the cartridge 100 further includes a cap 140 for capping the inlet 112 thereby forming a closed system when the cartridge 100 is in use (e.g., after the receiving sample is filled with the fluid sample).

When in use, the cartridge 100 is placed in stand-up position as depicted in FIG. 1C, and a fluid sample (e.g., a plasma or a saliva sample collected from a live subject and suspended in a buffer or saline solution) is introduced into the cartridge 100 through the inlet 112, for example, the fluid sample may be directly added into the receiving chamber 114 from the inlet 112 until it is leveled with the baffle plate 130 therein, in which the baffle plate 130 in the receiving chamber 114 serves as a structure for guiding the flow of the fluid sample and eliminating turbulent flow, if any. Additionally, the baffle plate 130 may also serve as an indicator of the volume of the fluid sample received in the receiving chamber 114, for example, the baffle plate 130 may be disposed at a pre-determined location in the receiving chamber 114 where the volume of the receiving chamber below the baffle plate 130 has been determined during the manufacture of the cartridge 100. Further, as the receiving chamber 114 has a round bottom, hence the plurality of fluid channels 118 connected thereto are not on the same level or same height, accordingly, the flow rate of the fluid sample in each fluid channel 118 may not be the same due to the differences in gravity. Referring to FIG. 1C again, in which the cartridge 100 is depicted to comprise six reaction chambers 116a-c, six fluid channels 118a-c and six air passages 120a-c evenly disposed on the left and right sides of the receiving chamber 114. Note that on either side of the receiving chamber 114, each fluid channel is in U-shaped and has a length different from that of another fluid channel; and the reaction chamber 116a closest to the receiving chamber 114 is connected thereto via the shortest fluid channel 118a, while the farthest reaction chamber 116c is connected thereto via the longest fluid channel 118c. By such arrangement, when the cartridge 100 is in use, the fluid in any reaction chamber 116a-c will be leveled with the fluid in another reaction chamber 116a-c.

Additionally, each reaction chambers 116 is further connected to a downstream air passage 120, which extends upward (i.e., in relative to the reaction chamber 116a-c) and remains open at its terminal 122 so that the fluid sample may flow through the cartridge 100 naturally via gravity, i.e., without applying additional electricity or force to drive the flow of the fluid sample.

Preferably, each reaction chamber 116 is pre-loaded with reactants (e.g., forward and reverse primers, DNA polymerase, deoxynucleotide triphosphates (dNTPs), reaction buffer and the like needed for a polymerase chain reaction) or has reactants contained therein, so that when the fluid sample (i.e., a biological sample diluted or suspended in a buffer solution) reaches the reaction chamber 116, designated reaction (e.g., PCR) may be carried out in each reaction chamber 116 (e.g., via heating). Optionally, each reaction chamber 116 may contain therein reactants different from those of another reaction chamber. In other words, the three reaction chambers may all perform the same reaction, or may respectively perform different reactions. Additionally or optionally, each reaction chamber 116 further includes a C-element disposed therein to hold the reactants in place. Reference is made to FIG. 1D, in which three reaction chambers 116a-c independently having a C-element 117a-c disposed therein are provided on either side of the receiving chamber 114. Each C-element 117a-c has an angular opening of about 20 to 120 degrees, such as 20, 30, 40, 50, 60, 70, 80, 90, 100, 110, 120, 130, 140, and 150 degrees. In this particular embodiment, on either side of the receiving chamber 114, three C-element 117a-c are respectively disposed in the three reaction chambers 116a-c and the three C-element 117a-c respectively have angular openings of about 60, 90 and 120 degrees.

Additionally or optionally, the cover 111 for covering the case 110 is made of a transparent material, so that a user may easily observe the operation of the cartridge, such as the volume of the fluid sample in the receiving chamber 114, the fluid level in each reaction chamber 116, the progress of the reaction occurred in each reaction chamber, and the like. Examples of the transparent material suitable for manufacturing the cover 111 include, but are not limited to, cellulose acetate butyrate, glass, polymethlamethacrylate (PMMA), polycarbonate (PC), polyethylene terephthalate (PET), glycol modified polyethylene terephthalate (PETG) and the like. Preferably, the cover 111 is made of PET.

Accordingly, it is the second aspect of the present disclosure to provide a system 280 for processing a fluid sample in vertical manner. The system 280 comprises a cartridge 200 of the present disclosure, a heating module 260 and a moving module 250 respectively coupled to the present cartridge 200 and moving the present cartridge 200 in vertical direction, and optionally, a detection module 270 for detecting the reaction products produced in the reaction chambers of the cartridge 200. Note that the moving module 250, the heating module 260, the detection module 270 and optionally, the present cartridge 200, are driven by electricity.

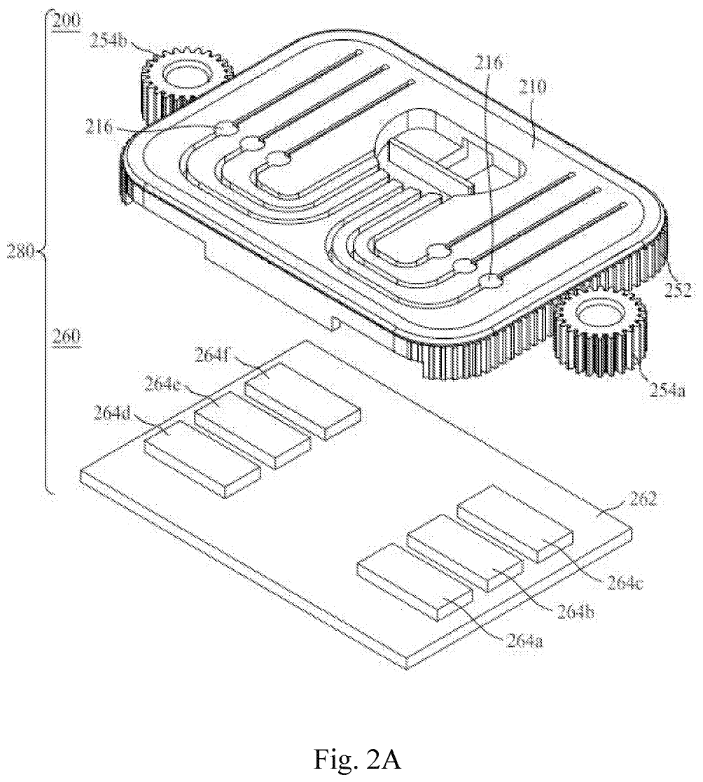

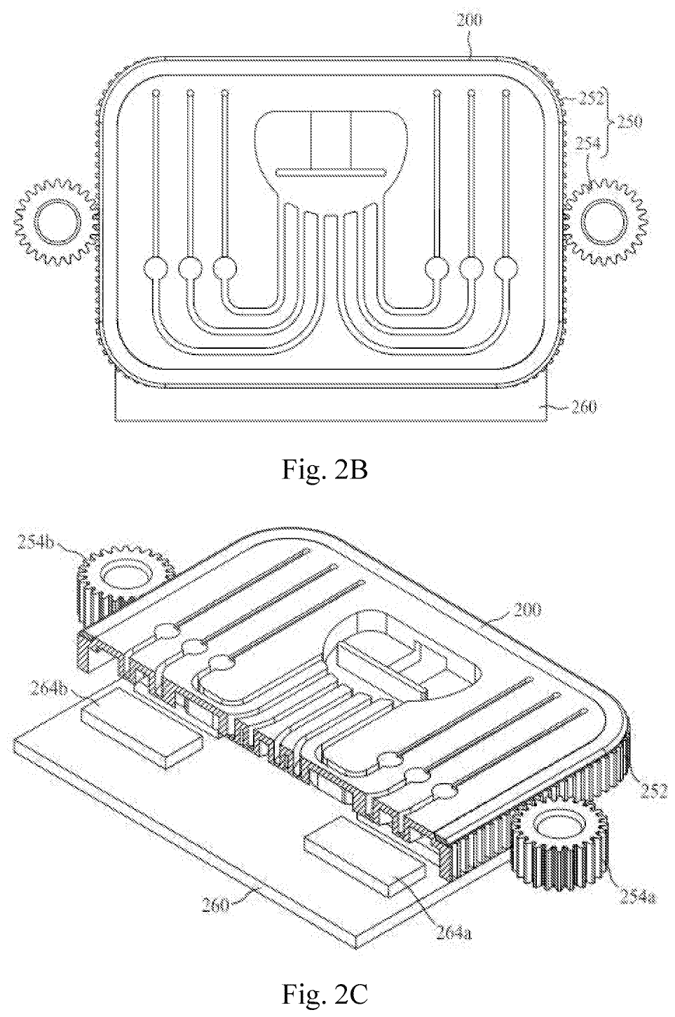

Referring to FIGS. 2A to 2C, in which FIG. 2A is an exploded view of the present system 280, FIG. 2B is the front view of the present system 280, and FIG. 2C is a perspective view of the present system 280. The moving module 250 comprises in its structure, a gear groove 252 disposed around the case 210 of the cartridge 200, and two gears 254a-b respectively disposed on each side of the case 210 for moving the cartridge 200 along the gear groove 252 in vertical direction. The heating module 260 includes a body 262, and a plurality of heating areas 264 evenly disposed on the left and right sides of the body 262. In the depicted embodiment, the heating module 260 is disposed in the back of the cartridge 200 and has a total of six heating areas 264a-f evenly disposed on the left and right sides of the body 262. The heating areas 264a-c and 264d-f on each side of the body 262 may be set to different pre-determined temperatures, such as the temperatures for the denaturation, annealing and extension of nucleic acids in PCR.

When the system 280 is at work, such as when set to perform a PCR, a fluid sample (e.g., a whole blood sample diluted with PBS) is directly applied from the inlet to the receiving chamber 214 until the fluid in all reaction chambers 216 are at the same level, note that each of the reaction chamber 216 contains therein suitable primers, dNTPs and polymerase needed for PCR. The two gears 254a-b are then driven to move the cartridge 200 along the groove 252 so as to place the reaction chambers 216 above suitable heating area 264 in sequence, for example, first above heating area 264a, 264d, which are set to about 94-98° C., the temperature suitable for denaturing nucleic acids; then above heating area 264b, 264e, which are set to about 55-70° C., the temperature suitable for annealing the denatured nucleic acids with primers; then finally above heating area 264c, 264f, which are set to about 68-75° C., the temperature suitable for the function of DNA polymerase thereby the extension of nucleic acids.

Additionally, the system 280 further includes a detection module 270 for detecting the reaction products produced in the reaction chambers 216 of the cartridge 200. In general, a skilled artisan may select a suitable device as the detection module 270 depending on the reaction products generated in the reaction chambers. For example, in the case when the system 280 is set to perform PCR, then the detection module 270 may be a spectrometer capable of detecting the amplicons by detecting the fluorescent dyes bound specifically to the doubled-stranded nucleic acids. Alternatively or optionally, if the system 280 is set to perform other reactions such as immunogenic reactions, then the detection module 270 may be devices suitable for detecting immunogenic products.

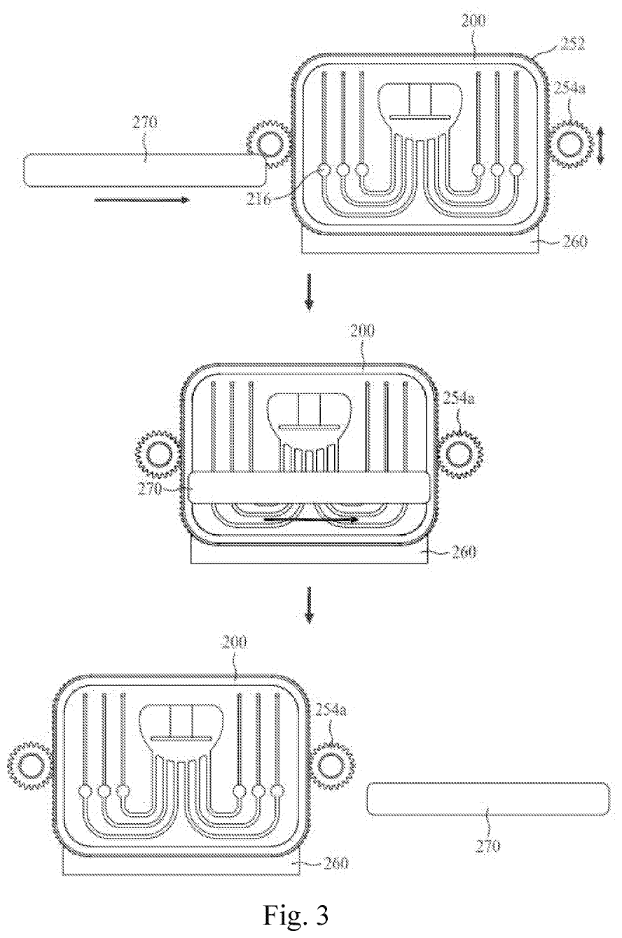

Reference is made to FIG. 3, which depicts the movement of the detection module 270 in relative to the cartridge 200 and the heating module 260 when the system 280 is at work (e.g., performing PCR). Prio to commencing of the process of the fluid sample or before any reaction product is produced in the reaction chamber 216, the detection module 270 is parked on one side of the cartridge 200 (FIG. 3, upper panel), upon completion of the reactions in the reaction chambers 216, the detection module 270 will move laterally from the parking site to the front of the cartridge 200 (FIG. 3, middle panel) so as to identifying the reaction products in the reaction chambers, and will continually move to the other side of the cartridge 200 (i.e., the side opposite to its original parking site) once the reaction products are successfully identified (FIG. 3, lower panel).

In sum, the present cartridge and the system comprising the same is capable of analyzing a fluid sample in vertical manner via using a minimum amount of the sample and completing the analysis in situ (i.e., without having the need to transfer the reaction products elsewhere for the final detection).

It will be understood that the above description of embodiments is given by way of example only and that various modifications may be made by those with ordinary skill in the art. The above specification, examples, and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A cartridge for processing a fluid sample vertically comprising a case and a cover for covering the case, wherein,
the case comprises a receiving chamber having a round bottom, a plurality of reaction chambers downstream to the receiving chamber, a plurality of fluid channels connecting the plurality of reaction chambers to the round bottom of the receiving chamber; and a plurality of air passages downstream to the plurality of reaction chambers and respectively connected thereto; and
the receiving chamber comprises an inlet for receiving the fluid sample, and a baffle plate disposed underneath the inlet and above the round bottom.

2. The cartridge of claim 1, wherein each reaction chamber is leveled with the other reaction chambers.

3. The cartridge of claim 1, wherein the cartridge has even numbers of the reaction chambers, the fluid channels and the air passages disposed evenly on the left and right sides of the receiving chamber.

4. The cartridge of claim 3, wherein the cartridge has six reaction chambers, six fluid channels and six air passages.

5. The cartridge of claim 4, wherein
each fluid channel is in U-shaped and has a length different from that of another fluid channel disposed on the same side of the receiving chamber; and
the six air passages respectively have the same lengths.

6. The cartridge of claim 1, wherein the baffle plate serves as an indicator for indicating the volume of the fluid sample received in the receiving chamber.

7. The cartridge of claim 1, further comprising a plurality of C-shaped elements respectively disposed within the plurality of reaction chambers.

8. The cartridge of claim 7, wherein each C-shaped elements has an angular opening ranging from about 20 to 120 degrees.

9. The cartridge of claim 8, wherein
the cartridge has six reaction chambers, six fluid channels and six air passages disposed evenly on the left and right side of the receiving chamber; and
the C-shaped elements disposed within the reaction chambers on the left or right sides of the receiving chamber respectively have the angular openings of 20, 60 and 120 degrees.

10. The cartridge of claim 9, wherein each reaction chamber is leveled with the other reaction chambers.

11. The cartridge of claim 10, wherein
each fluid channel is in U-shaped and has a length different from that of another fluid channel disposed on the same side of the receiving chamber; and
the six air passages respectively have the same lengths.

12. A system for processing a fluid sample vertically comprising:
the cartridge of claim 1;
a heating module coupled to the cartridge of claim 1 for elevating the temperature of each reaction chambers; and
a moving module coupled to the cartridge of claim 1 for moving the cartridge of claim 1 in vertical direction.

13. The system of claim 12, wherein the cartridge has even numbers of the reaction chambers, the fluid channels and the air passages disposed evenly on the left and right sides of the receiving chamber.

14. The system of claim 13, wherein the cartridge further comprises a plurality of C-shaped elements respectively disposed within the plurality of reaction chambers, and each C-shaped elements has an angular opening ranging from about 20 to 150 degrees.

15. The system of claim 14, wherein each reaction chamber is leveled with the other reaction chambers, and each fluid channel is in U-shaped and has a length different from that of another fluid channel disposed on the same side of the receiving chamber.

16. The system of claim 15, wherein,
the heating module comprises a heating plate and a plurality of heating areas evenly disposed on the left and right sides of the heating plate, and each heating area on the left or right sides has a temperature different from that of another heating area on the same side; and
the moving module comprises a gear groove disposed around the case and two gears respectively disposed on each side of the case for moving the cartridge along the gear groove in vertical direction.

17. The system of claim 16, further comprising a detection module for detecting the fluid sample in any one of the reacting chambers.

18. The system of claim 12, wherein the fluid sample is any one of a whole blood sample, a plasma sample, a serum sample, a urine sample, a mucus sample, a saliva sample, and purified or filtered forms thereof.
